(19) United States
(12) Patent Application Publication
(10) Pub. No.: US 2026/0163675 A1
(43) Pub. Date: Jun. 11, 2026

(54) DEVICE AND METHOD FOR DETECTING SYMBOL

(71) Applicant: Samsung Electronics Co., Ltd., Suwon-si (KR)

(72) Inventors: Soonwoo Choi, Suwon-si (KR); Tae Shin Park, Suwon-si (KR); Minki Ahn, Suwon-si (KR); Junyoung Jeong, Suwon-si (KR)

(73) Assignee: Samsung Electronics Co., Ltd., Suwon-si (KR)

(21) Appl. No.: 19/400,763

(22) Filed: Nov. 25, 2025

(30) Foreign Application Priority Data
Dec. 9, 2024 (KR) 10-2024-0182030
Feb. 5, 2025 (KR) 10-2025-0014316

(51) Int. Cl. H04L 1/00; H04L 5/00; H04L 25/03

(52) U.S. Cl. CPC H04L 1/0054; H04L 5/0048; H04L 25/03

(57) ABSTRACT

Provided is a device configured to detect a symbol from an input signal, the device including a Euclidean distance calculator configured to calculate a plurality of Euclidean distances corresponding to a plurality of candidate symbols, a minimum value detector configured to detect a minimum value among the plurality of Euclidean distances and a log-likelihood ratio (LLR) calculator configured to calculate an LLR based on the minimum value, and the minimum value detector includes a first circuit configured to detect a first minimum value of Euclidean distances corresponding to candidate symbols including an identical real part among the plurality of candidate symbols and a second circuit configured to detect a second minimum value of Euclidean distances corresponding to candidate symbols including an identical value in at least one bit of the real part among the plurality of candidate symbols, from a plurality of first minimum values including the first minimum value.

### CROSS-REFERENCE TO RELATED APPLICATIONS

This present application claims priority to and the benefit under 35 U.S.C. § 119(a)-(d) of Korean Patent Application No. 10-2024-0182030, filed on Dec. 9, 2024, and Korean Patent Application No. 10-2025-0014316, filed on Feb. 5, 2025, in the Korean Intellectual Property Office, the entire disclosures of which are incorporated herein by reference.

### BACKGROUND

Example embodiments relate to a demodulation, and specifically relate to a device and a method of detecting a symbol.

Modulation and demodulation may be used in communications. A transmitter may transmit a signal containing symbols by modulating data, and a receiver may detect the symbols by demodulating the received signals. As demands for throughput increase, the modulation order may be increased, and the number of bits corresponding to a symbol may increase. Further, the number of symbols to be detected may increase with multiple-input multiple-output (MIMO). Accordingly, a method for efficiently demodulating the modulated signal may be important.

### SUMMARY

Aspects provide a device and a method of detecting symbols at reduced cost.

According to aspects, there is provided a device configured to detect a symbol from an input signal, the device including a Euclidean distance calculator configured to calculate a plurality of Euclidean distances corresponding to a plurality of candidate symbols, a minimum value detector configured to detect a minimum value among the plurality of Euclidean distances, and a log-likelihood ratio (LLR) calculator configured to calculate an LLR based on the minimum value. The minimum value detector includes a first circuit configured to detect a first minimum value of Euclidean distances corresponding to candidate symbols having an identical real part among the plurality of candidate symbols, and a second circuit configured to detect a second minimum value of Euclidean distances corresponding to candidate symbols having an identical value in at least one bit of the real part among the plurality of candidate symbols, from a plurality of first minimum values including the first minimum value.

According to aspects, there is provided a method of detecting a symbol from an input signal, the method including calculating a plurality of Euclidean distances corresponding to a plurality of candidate symbols, detecting a minimum value among the plurality of Euclidean distances, and calculating an LLR based on the minimum value. The detecting the minimum value includes detecting a first minimum value of Euclidean distances corresponding to candidate symbols having an identical real part among the plurality of candidate symbols, and detecting a second minimum value of Euclidean distances corresponding to candidate symbols having an identical value in at least one bit of the real part among the plurality of candidate symbols, from a plurality of first minimum values including the first minimum value.

According to aspects, there is provided a method of detecting a symbol from an input signal, the method including generating a reference symbol based on the input signal, generating a plurality of candidate symbols based on the reference symbol, calculating a plurality of Euclidean distances corresponding to the plurality of candidate symbols, detecting a minimum value among the plurality of Euclidean distances, and calculating an LLR based on the minimum value. The generating the plurality of candidate symbols includes generating 5×5 first candidate symbols including the reference symbol in a signal constellation, generating three second candidate symbols having a real part that is identical to a real part of at least one among the first candidate symbols, and generating three third candidate symbols having an imaginary part that is identical to an imaginary part of at least one among the first candidate symbols.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a drawing illustrating a wireless communication system according to embodiments;

FIG. 2 is a block diagram illustrating a wireless communication system according to embodiments;

FIG. 3 is a block diagram illustrating a processing circuit according to embodiments;

FIG. 4 is a diagram illustrating a method for detecting a minimum Euclidean distance according to embodiments;

FIG. 5A and FIG. 5B are drawings illustrating a minimum value detector according to embodiments;

FIG. 6A and FIG. 6B are drawings illustrating candidate symbols generated according to embodiments;

FIG. 7 is a block diagram illustrating a processing circuit according to embodiments;

FIG. 8A and FIG. 8B are drawings illustrating candidate symbols generated according to embodiments;

FIG. 9 illustrates a table including mirror symbols according to embodiments;

FIG. 10 is a block diagram illustrating a processing circuit according to embodiments;

FIG. 11 is a block diagram illustrating a minimum value detector according to embodiments;

FIG. 12 is a block diagram illustrating a minimum value operation block according to embodiments;

FIG. 13A and FIG. 13B are block diagrams illustrating a minimum value operation block according to embodiments;

FIG. 14 is a flowchart illustrating a method for detecting a symbol according to embodiments;

FIG. 15 is a flowchart illustrating a method for detecting a symbol according to embodiments;

FIG. 16 is a flowchart illustrating a method for detecting a symbol according to embodiments;

FIG. 17 is a flowchart illustrating a method for detecting a symbol according to embodiments;

FIG. 18 is a flowchart illustrating a method for detecting a symbol according to embodiments; and

FIG. 19 is a drawing illustrating devices for wireless communication according to embodiments.

### DETAILED DESCRIPTION

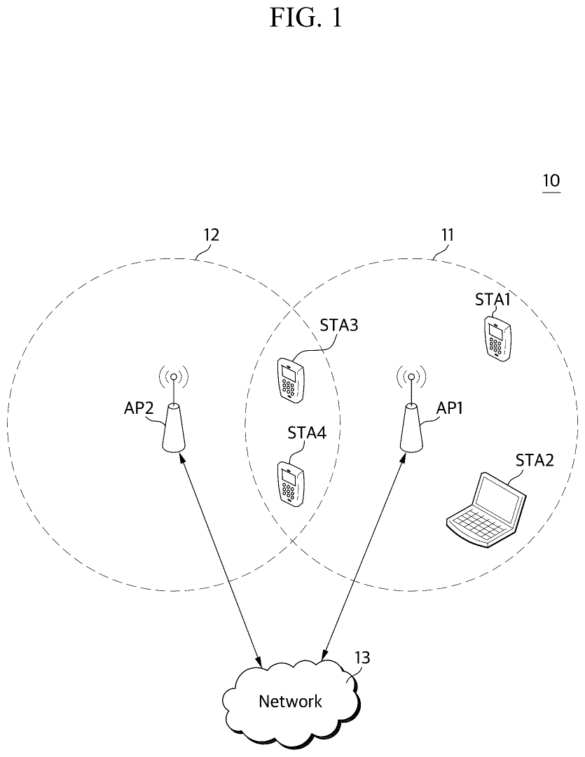

FIG. 1 is a drawing illustrating a wireless communication system 10 according to embodiments. Specifically, FIG. 1 illustrates a wireless local area network (WLAN) system as an example of the wireless communication system 10.

In describing example embodiments in detail, wireless communication systems based on OFDM or OFDMA, especially the IEEE 802.11 standard are mainly described. However, embodiments of the present disclosure is applicable to other communication systems having similar technical backgrounds and channel types, for example, cellular communication systems such as the long term evolution (LTE), the LTE-advanced (LTE-A), the new radio (NR), the wireless broadband (WiBro) and the global system for mobile communication (GSM), or short-distance communication systems such as Bluetooth and the near field communication (NFC), without departing from the scope of the present disclosure.

The various functions described below may be implemented or supported by Artificial Intelligence (AI) technology or one or more computer programs. Each of these programs consists of computer-readable program code and is implemented on a computer-readable medium. The terms “application” and “program” refer to one or more computer programs, software components, sets of instructions, procedures, functions, objects, classes, instances, associated data, or portions thereof suitable for implementing suitable computer-readable program code. The term “computer-readable program code” includes all types of computer code, including source code, object code, and executable code. The term “computer-readable medium” includes any type of media that may be accessed by a computer, such as read only memory (ROM), random access memory (RAM), a hard disk drive, a compact disc (CD), a digital video disc (DVD), and any other type of memory. A “non-transitory” computer-readable medium excludes wired, wireless, optical, or other communications links that transmit transitory electrical or other signals. The non-transitory computer-readable media include media on which data may be stored permanently, and media on which data may be stored and later overwritten, such as rewritable optical disks and erasable memory devices.

The various example embodiments of the present disclosure described below illustrate a hardware approach. However, since various example embodiments of the present disclosure include techniques using both hardware and software, various example embodiments of the present disclosure do not exclude software-based approaches. Further, the terms referring to control information, terms referring to entries, terms referring to network entities, terms referring to messages, terms referring to device components and so on used in the following description are examples for convenience of explanation. Therefore, the present disclosure is not limited to the terms described below, and other terms having equivalent technical meaning may be used.

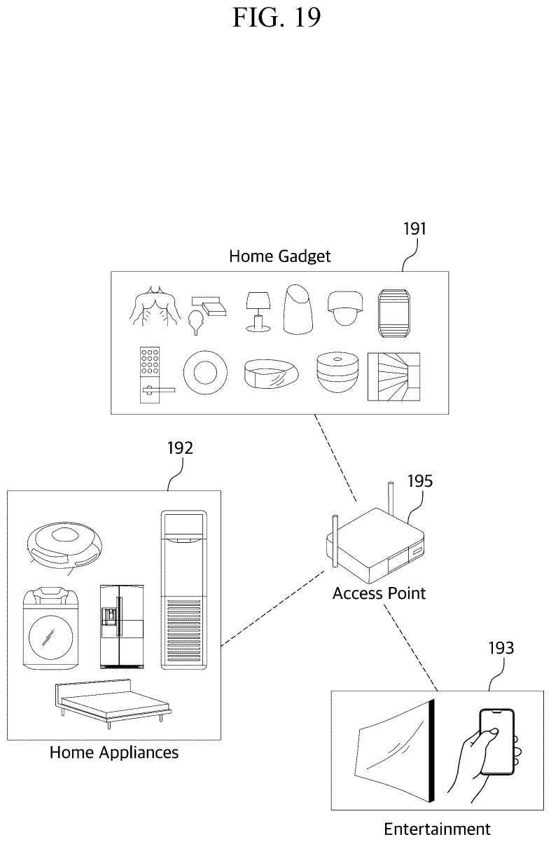

Referring to FIG. 1, the wireless communication system 10 may include a first access point AP1 and a second access point AP2, a first station STA1, a second station STA2, a third station STA3, and a fourth station STA4. The first access point AP1 and the second access point AP2 may connect to a network 13 including the Internet, an internet protocol (IP) network, or any other arbitrary network. The first access point AP1 may provide access to the network 13 within a first coverage area 11 to the first station STA1, the second station STA2, the third station STA3 and the fourth station STA4, and the second access point AP2 may also provide access to the network 13 within a second coverage area 12 to the third station STA3 and the fourth station STA4. In some example embodiments, based on wireless fidelity (WiFi) or any other WLAN access technology, the first access point AP1 and the second access point AP2 may communicate with at least one station among the first station STA1, the second station STA2, the third station STA3 and the fourth station STA4. Example embodiments of access points and stations will be described below with reference to FIG. 19.

An access point may be referred to as a router, gateway and so on, and a station may be referred to as a mobile station, a subscriber station, a terminal, a mobile terminal, a wireless terminal, user equipment, or a user. The station may be a mobile device, for example, a mobile phone, a laptop computer or a wearable device, and the station may be a stationary device, for example, a desktop computer or smart TV. In some example embodiments, an access point (for example, the first access point AP1) and a station (for example, the first station STA1) may be collectively referred to as communication devices, a device that transmits a signal may be referred to as a transmitting device, and a device that receives a signal may be referred to as a receiving device.

The transmitting device may transmit a modulated signal to a receiving device. For example, the first access point AP1 may generate a modulated signal according to a predefined modulation scheme, and transmit the signal to the first station STA1. The first station STA1 may demodulate the signal received from the first access point AP1 according to a predefined modulation scheme, and obtain information from the demodulated signal. With regard to the wireless communication system 10, higher order modulation schemes are specified for increasing throughput, and the transmitting device and the receiving device may include structures for supporting higher order modulation schemes. As described below with reference to the drawings, a symbol may be detected with reduced resources at the receiving device, and accordingly, symbols may be detected at low cost despite the increase in modulation order. Further, the area and power consumed for detection may be reduced, and the efficiency of the receiving device may be increased.

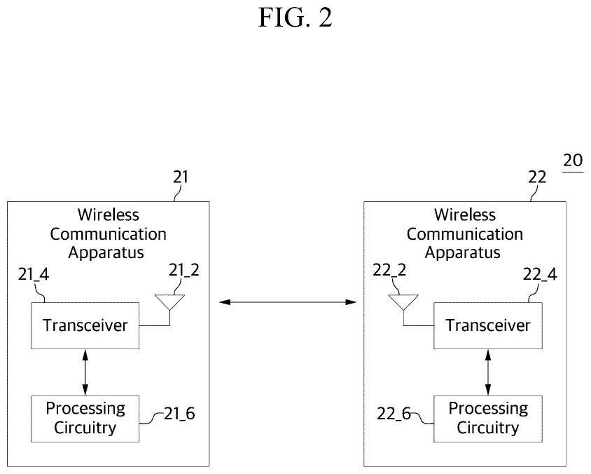

FIG. 2 is a block diagram illustrating a wireless communication system 20 according to embodiments. Specifically, the block diagram illustrates a first wireless communication device 21 and a second wireless communication device 22 communicating with each other in the wireless communication system 20. Each of the first wireless communication device 21 and the second wireless communication device 22 of FIG. 2 may be any device communicating in the wireless communication system 20, and may be referred to as a device for wireless communication or simply a device. In some example embodiments, each of the first wireless communication device 21 and the second wireless communication device 22 may be an access point or a station in a WLAN system.

Referring to FIG. 2, the first wireless communication device 21 may include an antenna 212, a transceiver 214, and a processing circuit 21_6. In some example embodiments, the antenna 212, the transceiver 21_4 and the processing circuit 216 may be included in one package, or may be included in different packages. The second wireless communication device 22 may also include an antenna 222, a transceiver 224, and a processing circuit 22_6. Hereinafter, repetitive descriptions of the first wireless communication device 21 and the second wireless communication device 22 will be omitted.

The antenna 212 may receive a signal from the second wireless communication device 22 and provide the signal to the transceiver 214, and may also transmit the signal provided from the transceiver 21_4 to the second wireless communication device 22. In some example embodiments, the antenna 21_2 may include multiple antennas for the MIMO. Further, in some example embodiments, the antenna 212 may include a phased array for beamforming.

The transceiver 21_4 may process signals received from the second wireless communication device 22 via the antenna 212, and may provide processed signals to the processing circuit 21_6. Further, the transceiver 214 may process signals provided from the processing circuit 216, and output the processed signal through the antenna 21_2. In some example embodiments, the transceiver 21_4 may include analog circuits such as low noise amplifier, mixer, filter, power amplifier, oscillator, and so on. In some example embodiments, the transceiver 21_4 may process a signal received from the antenna 21_2 and/or a signal received from the processing circuit 21_6 based on the control of the processing circuit 21_6.

The processing circuit 216 may extract information transmitted by the second wireless communication device 22 by processing the signal received from the transceiver 21_4. For example, the processing circuit 21_6 may extract information by demodulating and/or decoding the signal received from the transceiver 21_4. Further, a signal containing information to be transmitted to the second wireless communication device 22 may be generated and provided to the transceiver 21_4. For example, the processing circuit 21_6 may provide a signal generated by encoding and/or modulating data to be transmitted to the second wireless communication device 22 to the transceiver 21_4. In some example embodiments, the processing circuit 21_6 may include programmable components such as a central processing unit (CPU), a digital signal processor (DSP) and so on, may include reconfigurable components, such as a field programmable gate array (FPGA), and may include components that provide fixed functions, such as an intellectual property (IP) core. In some example embodiments, the processing circuit 216 may include or may access memory that stores data and/or a series of instructions.

Herein, the transceiver 21_4 and/or the processing circuit 21_6 performing operations may be simply referred to as the first wireless communication device 21 performing the operations. Accordingly, operations performed by the access point may be performed by the transceiver and/or the processing circuit included in the access point, and operations performed by the station may be performed by a transceiver and/or processing circuit included in the station.

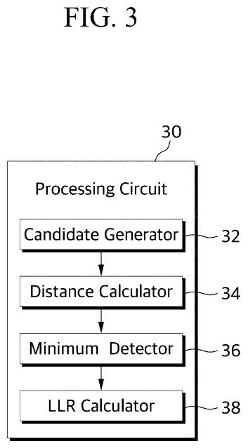

FIG. 3 is a block diagram illustrating a processing circuit 30 according to embodiments. For example, the block diagram of FIG. 3 illustrates the processing circuit 30 as an example of the processing circuits 21_6 and 22_6 of FIG. 2. As illustrated in FIG. 3, the processing circuit 30 may include a candidate generator 32, a distance calculator 34, a minimum value detector 36, and an LLR calculator 38. The candidate generator 32, the distance calculator 34, the minimum value detector 36 and the LLR calculator 38 may perform operations to detect a symbol from a modulated signal. Herein, the modulated signal may be referred to as the input signal, and the processing circuit 30 may be referred to as a device that detects a symbol from the input signal.

The candidate generator 32 may generate at least one candidate symbol among the symbols defined by the modulation scheme. In some example embodiments, the candidate generator 32 may generate all symbols defined by the modulation scheme as candidate symbols. In some example embodiments, the candidate generator 32 may generate some of the symbols defined by the modulation scheme as candidate symbols. Among the candidate symbols generated by the candidate generator 32, a candidate symbol most suitable for the input signal may be detected as the final symbol. The candidate generator 32 may provide candidate symbols to the distance calculator 34.

The distance calculator 34 may calculate Euclidean distances corresponding to candidate symbols. The Euclidean distance may refer to the distance between two points in a signal constellation, and the closer the Euclidean distance, the higher the similarity. The distance calculator 34 may calculate Euclidean distances between points corresponding to candidate symbols and a point corresponding to an input signal. The distance calculator 34 may provide the calculated Euclidean distances to the minimum value detector 36. Herein, the Euclidean distance may be simply referred to as distance.

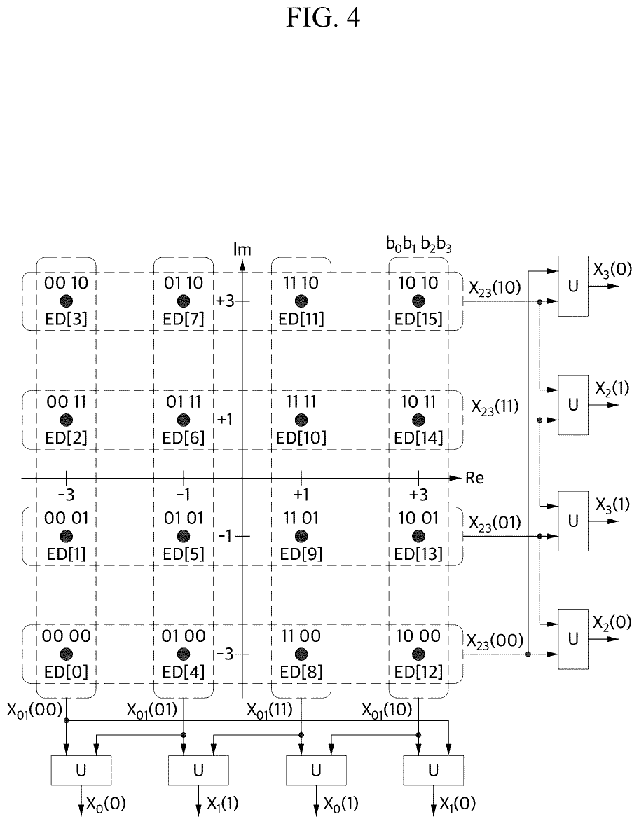

The minimum value detector 36 may detect a minimum value among Euclidean distances. For example, the minimum value detector 36 may detect the minimum Euclidean distance, in other words, the minimum value, among the Euclidean distances provided by the distance calculator 34. As the modulation order increases, the number of bits in a symbol may increase. Accordingly, the complexity of the minimum value detector 36 may increase. As described below with reference to FIG. 4 and so on, the minimum value detector 36 may detect the minimum value (hereinafter referred to as the first minimum value) of Euclidean distances corresponding to candidate symbols having the same real part (or the same imaginary part), and the minimum value detector 36 may detect the minimum value (hereinafter referred to as the second minimum value) of Euclidean distances corresponding to candidate symbols having the same value in at least one bit of the real part (or imaginary part) from the first minimum values. Accordingly, a minimum value detector 366 may detect minimum values using reduced resources. Herein, the operation of finding the first minimum value may be referred to as the first stage, and the operation of finding the second minimum value from the first minimum values may be referred to as the second stage.

The LLR calculator 38 may calculate an LLR based on minimum values. For example, when a 2×2 MIMO packet is transmitted, the received signal y may be expressed as [Equation 1] below.

$$y = Hx + n = {h}_{0} {x}_{0} + {h}_{1} {x}_{1} + n \qquad [ Equation 1 ]$$

In [Equation 1], H=[h₀, h₁] is a 2×2 channel matrix. x=[x₀, x₁]^{T} are two symbols transmitted from the transmitting device. n is an additive white Gaussian noise (AWGN) vector whose covariance is E{nn^{H}}=ν²I.

The LLR value, which is the soft decision value of the i-th bit b_{s,i} of the s-th spatial stream, may be expressed as [Equation 2] below (s and i are integers greater than 0).

$$LLR ( {b}_{s , i} ) = log ( \frac{P ( y \vert {b}_{s , i} = 1 )}{P ( y \vert {b}_{s , i} = 0 )} ) . \qquad [ Equation 2 ]$$

In [Equation 2], P(y|b_{s,i}=1) may indicate the probability that b_{s,i} is 1, and P(y|b_{s,i}=0) may indicate the probability that b_{s,i} is 0. Using the Gaussian distribution with mean 0 and variance 1, the conditional probability density function may be expressed as [Equation 3] below.

$$LLR ( {b}_{s , i} ) = log ( \frac{{\sum }_{x ∈ {X}_{s , i} ( 1 )} exp [ - {‖ y - {h}_{0} {x}_{0} - {h}_{1} {x}_{1} ‖}^{2}}{{\sum }_{x ∈ {X}_{s , i} ( 0 )} exp [ - {‖ y - {h}_{0} {x}_{0} - {h}_{1} {x}_{1} ‖}^{2}} ) \qquad [ Equation 3 ]$$

In [Equation 3], X_{s,i}(0) is the set of symbols where the value of b_{s,i} is 0, and X_{s,i}(1) is the set of symbols where the value of b_{s,i} is 1. For example, X_{s,i}(0) contains the combination of symbols in spatial stream 0 for which the value of b_{s,i} is 0 and symbols in spatial stream 1 for all signal constellation points. Through Max-log simplification, b_{s,i} may be simplified as shown in [Equation 4] below, and in [Equation 4], ∥y−h₀x₀−h₁x₁∥² represents the Euclidean distance.

$$LLR ( {b}_{s , i} ) \approx {min}_{x ∈ {X}_{s , i} ( 0 )} {‖ y - {h}_{0} {x}_{0} - {h}_{1} {x}_{1} ‖}^{2} - {min}_{x ∈ {X}_{s , i} ( 1 )} {‖ y - {h}_{0} {x}_{0} - {h}_{1} {x}_{1} ‖}^{2} \qquad [ Equation 4 ]$$

FIG. 4 is a diagram illustrating a method for detecting a minimum Euclidean distance according to embodiments. For example, FIG. 4 illustrates the operation of detecting the minimum value among 16 Euclidean distances (ED[0:15]) corresponding to all symbols in the signal constellation of 16-quadrature amplitude modulation (QAM). The 16-QAM in FIG. 4 is only an example, and it should be noted that the method described below may be applied to other modulation schemes as well.

As described above with reference to FIG. 3, in the first stage, the minimum value of candidate symbols having the same real part (or the same imaginary part), in other words, the first minimum value, may be detected first, and in the second stage, overall minimum values of candidate symbols may be detected from the first minimum values. For example, a 16-QAM symbol may have four bits which are b₀b₁b₂b₃, and the sets where the values of the bit b₀ of the real part are 0 and 1 are defined as X₀(0) and X₀(1), respectively, and the sets where the values of b₁ are 0 and 1 are defined as X₁(0) and X₁(1), respectively. X₀₁(00) is defined as the set where b₀ and b₁ are 0 and 0, respectively, and may be the intersection of X₀(0) and X₁(0).

As shown in [Equation 5] below, each of minimum values for the four values of the real part detected in the first stage, in order words,

$${min}_{x ∈ {X}_{01} ( 00 )} ED ( x ) , {min}_{x ∈ {X}_{01} ( 01 )} ED ( x ) , {min}_{x ∈ {X}_{01} ( 10 )} ED ( x ) and {min}_{x ∈ {X}_{01} ( 11 )} ED ( x ) ,$$

may be commonly used to obtain the minimum value of each of the two bits.

$${min}_{x ∈ {X}_{0} ( 0 )} ED ( x ) = min ( {min}_{x ∈ {X}_{01} ( 00 )} ED ( x ) , {min}_{x ∈ {X}_{01} ( 01 )} ED ( x ) ) \qquad [ Equation 5 ]$$

$${min}_{x ∈ {X}_{0} ( 1 )} ED ( x ) = min ( {min}_{x ∈ {X}_{01} ( 10 )} ED ( x ) , {min}_{x ∈ {X}_{01} ( 11 )} ED ( x ) )$$

$${min}_{x ∈ {X}_{1} ( 0 )} ED ( x ) = min ( {min}_{x ∈ {X}_{01} ( 00 )} ED ( x ) , {min}_{x ∈ {X}_{01} ( 10 )} ED ( x ) )$$

$${min}_{x ∈ {X}_{1} ( 1 )} ED ( x ) = min ( {min}_{x ∈ {X}_{01} ( 01 )} ED ( x ) , {min}_{x ∈ {X}_{01} ( 11 )} ED ( x ) )$$

For example, in [Equation 5],

$${min}_{x ∈ {X}_{01} ( 00 )} ED ( x )$$

may be used commonly for

$${min}_{x ∈ {X}_{0} ( 0 )} ED ( x ) and {min}_{x ∈ {X}_{1} ( 0 )} ED ( x ) .$$

Accordingly, the number of operations to derive the minimum value may be reduced.

[Equation 6] represents the relationship between sets of candidate symbols used in [Equation 5].

$${X}_{0} ( 0 ) = {X}_{01} ( 00 ) ⋃ {X}_{01} ( 01 ) \qquad [ Equation 6 ]$$

$${X}_{0} ( 1 ) = {X}_{01} ( 10 ) ⋃ {X}_{01} ( 11 )$$

$${X}_{1} ( 0 ) = {X}_{01} ( 00 ) ⋃ {X}_{01} ( 01 )$$

$${X}_{1} ( 1 ) = {X}_{01} ( 01 ) ⋃ {X}_{01} ( 11 )$$

As in [Equation 6], the set of symbols corresponding to one bit may correspond to the union of sets of symbols with the same real part. FIG. 4 illustrates the relationship between sets of candidate symbols expressed as [Equation 6] in the signal constellation of 16-QAM. The two bits of the imaginary part, b₂ and b₃, may also have their minimum values detected in the same way as b₀ and b₁ described above.

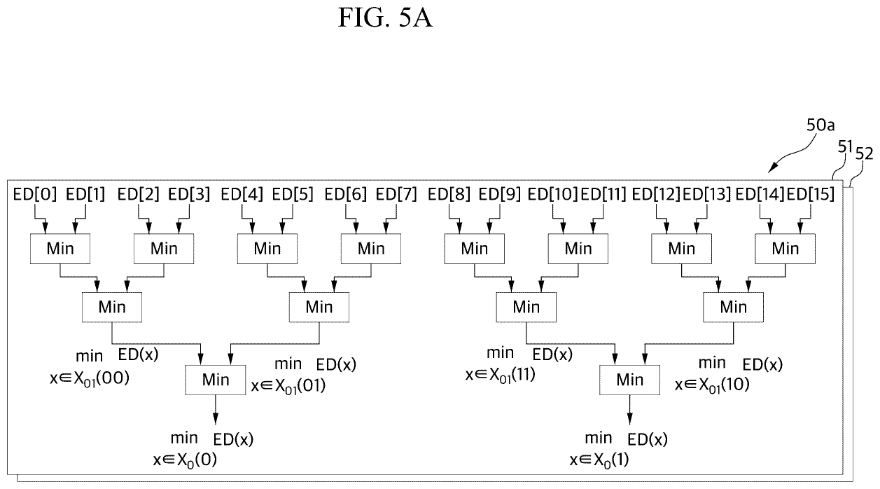

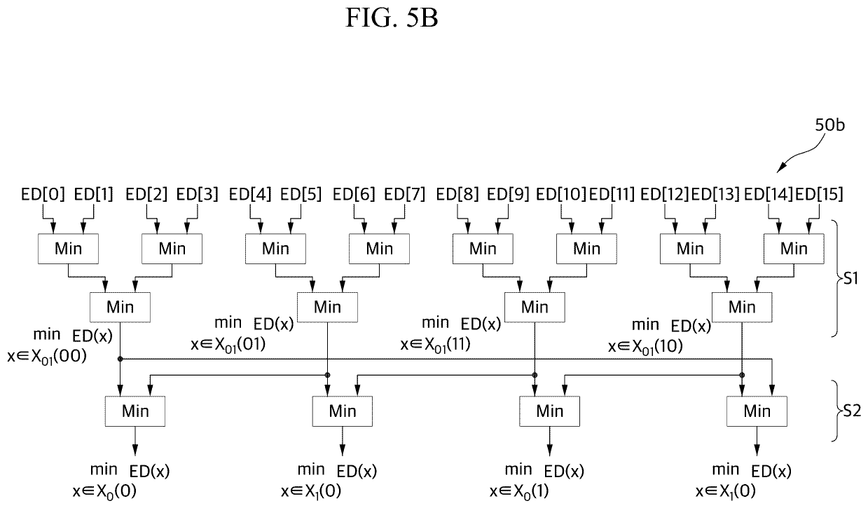

FIG. 5A and FIG. 5B are drawings illustrating a minimum value detector according to embodiments. For example, FIG. 5A and FIG. 5B show minimum value detectors 50a and 50b for calculating LLRs of b₀ and b₁ included in the real part of all symbols of 16-QAM.

Referring to FIG. 5A, the minimum value detector 50a may include a first part 51 for computing the LLR of b0 and a second part 52 for computing the LLR of b1. The 16 Euclidean distances (ED[0:15]) of FIG. 5A may be the 16 Euclidean distances (ED[0:15]) of FIG. 4. Eight Euclidean distances (ED[0:7]) may correspond to the symbol set X₀(0), and eight Euclidean distances (ED[8:15]) may correspond to X₀(1). As illustrated in FIG. 5A, in order to detect the minimum value of eight Euclidean distances, it may be implemented as a 3-stage tree including seven minimum value calculators. Accordingly, the first part 51 may include 14 minimum value calculators. The second part 52 may also include 14 minimum value calculators, and as a result, 28 minimum value calculators may be used in the real part. 28 minimum value calculators may also be used in b₂ and b₃ of the imaginary part, and as a result, the minimum value detector 50a may include up to 56 minimum value calculators. Herein, a minimum value calculator may refer to a circuit that compares two inputs and outputs the smaller value of the two inputs.

Referring to FIG. 5B, in a first stage S1, the minimum value of the Euclidean distances calculated in each of X₀₁(00), X₀₁(01), X₀₁(10) and X₀₁(11), which are sets of symbols with the same real part, may be detected, and by sharing the detected minimum values in a second stage S2, the minimum value of the Euclidean distances calculated in each of the four sets X₀(0), X₀(1), X₁(0) and X₁(1) for calculating the LLR of b₀ and b₁ may be detected. As illustrated in FIG. 5B, 16 minimum value calculators may be used for b₀ and b₁ of the real part, and, 16 minimum value calculators may be used for b₂ and b₃ of the imaginary part. As a result, the minimum value detector 50b may include up to 32 minimum value calculators.

When m is an integer greater than 1, in 2^{m}-QAM, a minimum value detector with a structure like FIG. 5A may include 2m trees for two values of each of the m bits in one bit stream. Each of the trees may include ½(2^{m}−1) minimum value calculators. Accordingly, the number N_{Separate} of minimum value calculators included in a minimum value detector having a structure similar to FIG. 5A may be expressed as [Equation 7] below.

$${N}_{Separate} = 2 m \cdot ( \frac{1}{2} \cdot {2}^{m} - 1 ) \qquad [ Equation 7 ]$$

The number N_{Merged} of minimum value calculators included in a minimum value detector having a structure similar to FIG. 5B in 2^{m}-QAM may be expressed as [Equation 8] below.

$${N}_{Merged} = 2 \cdot {2}^{\frac{m}{2}} \cdot ( {2}^{\frac{m}{2}} - 1 ) + 2 m \cdot ( \frac{1}{2} \cdot {2}^{\frac{m}{2}} - 1 ) \qquad [ Equation 8 ]$$

There may be 2^{m/2} candidate symbols in each of the real part and the imaginary part. When detecting the minimum value at Euclidean distances of 2^{m/2} symbols, (2^{m/2}−1) minimum value calculators may be used. Since there are 2^{m/2} candidate symbols in each of the real part and imaginary part, 2^{m/2+1} minimum value calculators may be used. The first term in [Equation 8] represents the number of minimum value calculators included in the first stage, and the second term in [Equation 8] represents the number of minimum value calculators included in the second stage. As a result, the structure of FIG. 5A may have as a complexity of O(m·2^{m}), and the structure of FIG. 5B may have a reduced complexity of O(2^{m}).

[Table 1] below shows the number and decrease rate of minimum value calculators calculated by [Equation 7] and [Equation 8] according to the modulation order.

TABLE 1

| | | | Decrease |
|---|---|---|---|
| modulation order | Equation 7 | Equation 8 | rate(%) |
| 16-QAM (m = 4) | 56 | 32 | 42.9% |
| 64-QAM (m = 6) | 372 | 148 | 60.2% |
| 256-QAM (m = 8) | 2032 | 592 | 70.9% |
| 1024-QAM (m = 10) | 10220 | 2284 | 77.7% |
| 4096-QAM (m = 12) | 49128 | 8808 | 82.1% |

As shown in [Table 1], as the modulation order increases, the rate at which the number of minimum value calculators decreases may increase.

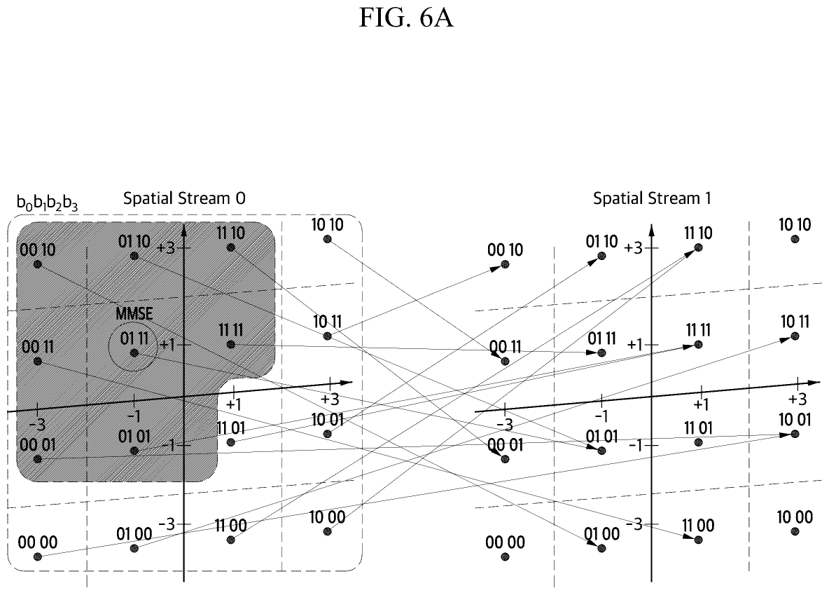

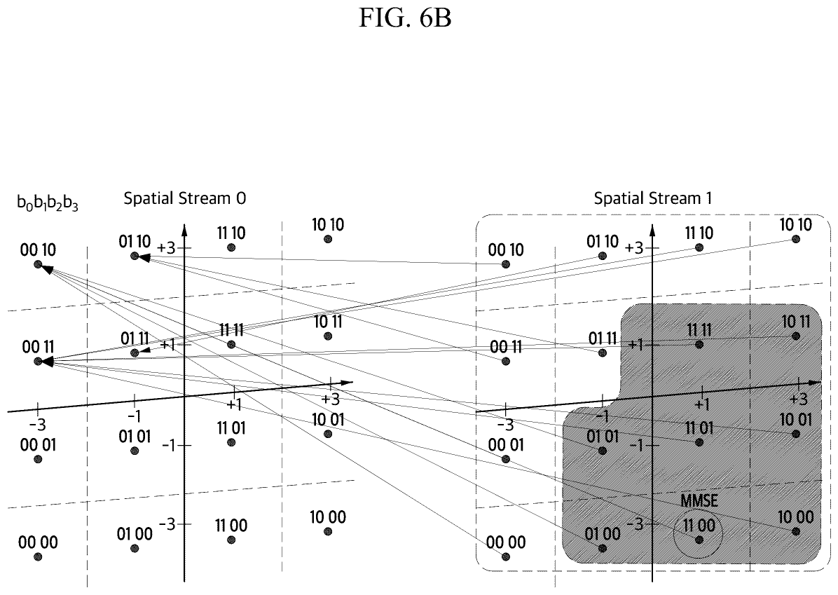

FIG. 6A and FIG. 6B are drawings illustrating candidate symbols generated according to embodiments. For example, FIG. 6A and FIG. 6B show candidate symbols generated for a signal received via two spatial streams based on 16-QAM.

All symbols of a modulation scheme may be generated as candidate symbols, and this method may be referred to as exhaustive search. The exhaustive search may calculate ∥y−h₀x₀−h₁x₁∥² in [Equation 4] for all combinations of symbols of a modulation scheme to calculate LLR. As shown in [Table 1], as the modulation order (in other words, m) increases, the number of combinations of symbols considered in exhaustive search may increase significantly.

Candidate symbols may be generated as a subset of all symbols of a modulation scheme, and the method may be referred to as initial candidate reduction (ICR). For example, a reference symbol may be computed based on the input signal, and candidate symbols may be generated based on the reference symbol. In some example embodiments, for signals received via two or more spatial streams, candidate symbols generated from one spatial stream may be used to generate candidate symbols from another spatial stream, and the method may be referred to as a dimension reduction soft demodulator (DRSD). For example, as illustrated on the left side of FIG. 6A, in spatial stream 0, “0111” may be generated as a reference symbol, and 8 candidate symbols including the reference symbol may be generated. Further, as illustrated on the right side of FIG. 6B, in spatial stream 1, “1100” may be generated as a reference symbol, and 8 candidate symbols including the reference symbol may be generated. In some example embodiments, the reference symbol may be calculated from the input signal by a minimum mean square error (MMSE) estimator. For example, the reference symbol x_{MMSE,0} calculated from spatial stream 0 and the reference symbol x_{MMSE,1} calculated from spatial stream 1 may be calculated as shown in [Equation 9] below.

$${x}_{MMSE , 0} = \frac{( ( {\vert {h}_{1} \vert}^{2} + {σ}^{2} ) {h}_{0}^{H} y - {h}_{0}^{H} {h}_{1} {h}_{1}^{H} y )}{( {\vert {h}_{1} \vert}^{2} + {σ}^{2} ) ( {\vert {h}_{0} \vert}^{2} + {σ}^{2} ) - {\vert {h}_{0}^{H} {h}_{1} \vert}^{2}} \qquad [ Equation 9 ]$$

$${x}_{MMSE , 1} = \frac{( ( {\vert {h}_{0} \vert}^{2} + {σ}^{2} ) {h}_{1}^{H} y - {h}_{1}^{H} {h}_{0} {h}_{0}^{H} y )}{( {\vert {h}_{1} \vert}^{2} + {σ}^{2} ) ( {\vert {h}_{0} \vert}^{2} + {σ}^{2} ) - {\vert {h}_{1}^{H} {h}_{0} \vert}^{2}}$$

In some example embodiments, as shown in [Equation 10] below, candidate symbol \hat{x}₁(x₀) of spatial stream 1 may be calculated from candidate symbol x₀ of spatial stream 0, and candidate symbol \hat{x}₀(x₁) of spatial stream 0 may be computed from candidate symbol x₁ of spatial stream 1.

$${\hat{x}}_{1} ( {x}_{0} ) = {argmin}_{{x}_{1}} {‖ y - {h}_{0} {x}_{0} - {h}_{1} {x}_{1} ‖}^{2} \qquad [ Equation 10 ]$$

$${\hat{x}}_{0} ( {x}_{1} ) = {argmin}_{{x}_{0}} {‖ y - {h}_{0} {x}_{0} - {h}_{1} {x}_{1} ‖}^{2}$$

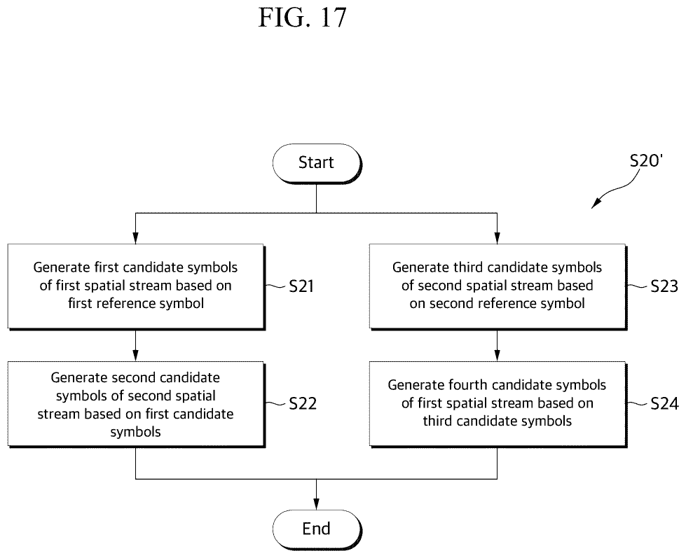

In [Equation 10], candidate symbol \hat{x}₁(x₀) of spatial stream 1 and candidate symbol \hat{x}₀(x₁) of spatial stream 0 may be referred to as hard detected symbols. FIG. 6A illustrates candidate symbols of spatial stream 1 generated from candidate symbols of spatial stream 0. FIG. 6B illustrates candidate symbols of spatial stream 0 generated from candidate symbols of spatial stream 1. In some example embodiments, as described below with reference to FIG. 17, hard detected symbols computed in other spatial streams may be added as candidate symbols.

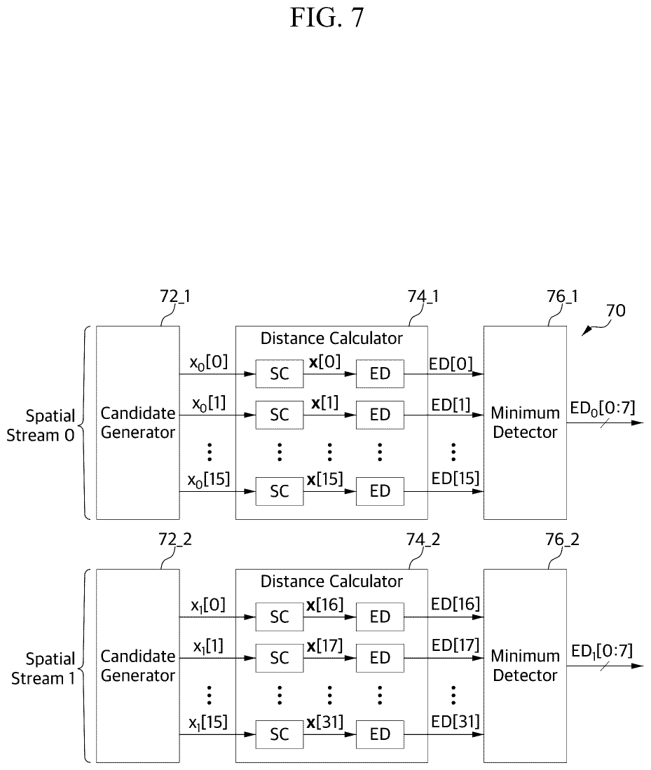

FIG. 7 is a block diagram illustrating a processing circuit 70 according to embodiments. For example, the block diagram of FIG. 7 illustrates the processing circuit 70 that uses all symbols supporting 16-QAM in 2×2 MIMO as candidate symbols. As illustrated in FIG. 7, the processing circuit 70 may include a first candidate generator 72_1, a first distance calculator 74_1 and a first minimum value detector 76_1 for spatial stream 0, and the processing circuit 70 may include a second candidate generator 722, a second distance calculator 74_2 and a second minimum value detector 76_2 for spatial stream 1.

In the case of the exhaustive search, the minimum value detector may not consider the Euclidean distance of hard detected symbols computed in other spatial streams. For example, the Euclidean distance of a hard detected symbol calculated in spatial stream 1 may be greater than or equal to the Euclidean distance of a candidate symbol at the same location in spatial stream 0. Accordingly, as illustrated in FIG. 7, in the exhaustive search, the operation of detecting the minimum Euclidean distance may be independent for each spatial stream.

The first candidate generator 72_1 may generate all symbols of 16-QAM in spatial stream 0 as candidate symbols. For example, as illustrated in FIG. 7, the first candidate generator 721 may generate 16 candidate symbols (x₀[0:15]). 16 candidate symbols (x₀[0:15]) may be provided to the first distance calculator 74_1. The first distance calculator 741 may include 16 slicers SC and 16 Euclidean distance calculators ED. The slicer SC of the first distance calculator 74_1 may compute the hard detected symbol of spatial stream 1. Accordingly, 16 symbol combinations (x[0:15]) may be generated. The Euclidean distance calculator ED may calculate the Euclidean distance from a combination of symbols. Accordingly, 16 Euclidean distances (ED[0:15]) may be generated. The first minimum value detector 76_1 may detect a total of eight minimum values (ED₀[0:7]), corresponding to two values each of the four bits of spatial stream 0, for example, b_{0,0}, b_{0,1}, b_{0,2} and b_{0,3} from the 16 Euclidean distances (ED[0:15]). Eight minimum values (ED₀[0:7]) may be provided to the LLR calculator (for example, the LLR calculator 38 in FIG. 3), and the LLR calculator may compute LLR values of b_{0,0}, b_{0,1}, b_{0,2} and b_{0,3} of spatial stream 0.

The second candidate generator 722 may generate all symbols of 16-QAM in spatial stream 1 as candidate symbols. For example, as illustrated in FIG. 7, the second candidate generator 72_2 may generate 16 candidate symbols (x₁[0:15]). 16 candidate symbols (x₁[0:15]) may be provided to the second distance calculator 74_2. The second distance calculator 74_2 may include 16 slicers SC and 16 Euclidean distance calculators ED. The slicers SC of the second distance calculator 74_2 may compute the hard detected symbol of spatial stream 0. Accordingly, 16 symbol combinations (x[16:31]) may be generated. The Euclidean distance calculator ED may calculate the Euclidean distance from a combination of symbols. Accordingly, 16 Euclidean distances (ED[16:31]) may be generated. From 16 Euclidean distances (ED[16:31]), the second minimum value detector 76_2 may detect a total of eight minimum values (ED₁[0:7]), corresponding to two values each of four bits: b_{1,0}, b_{1,1}, b_{1,2} and b_{1,3}. Eight minimum values (ED₁[0:7]) may be provided to the LLR calculator (for example, the LLR calculator 38 in FIG. 3), and the LLR calculator may compute LLR values of b_{1,0}, b_{1,1}, b_{1,2} and b_{1,3} of spatial stream 1.

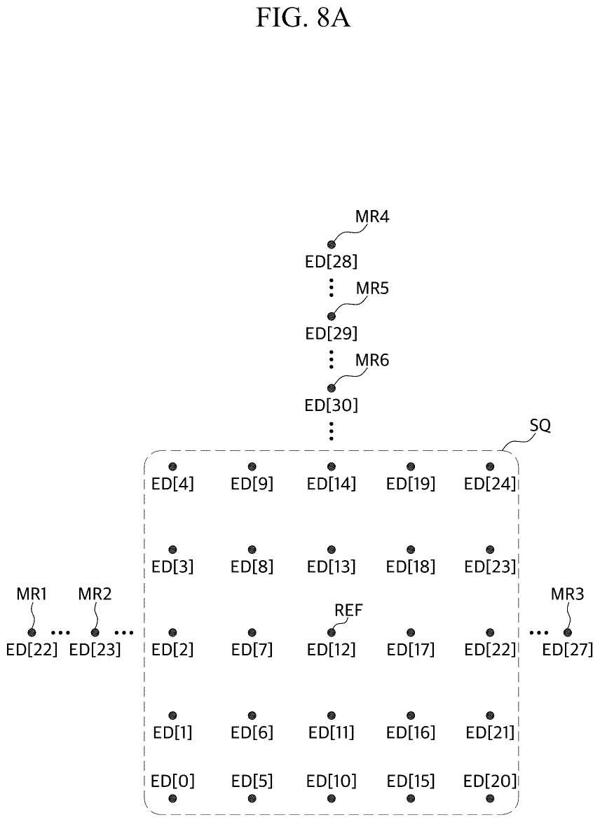

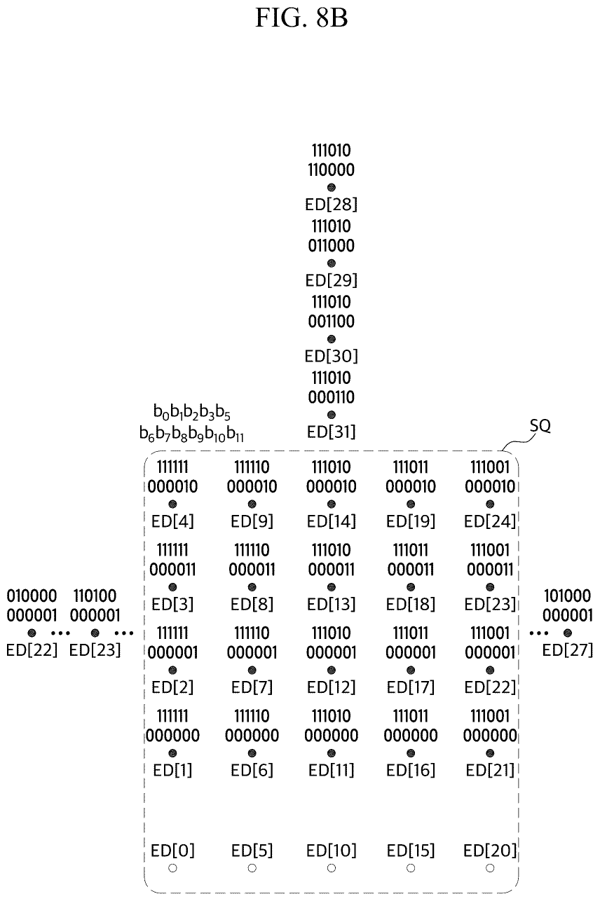

FIG. 8A and FIG. 8B are drawings illustrating candidate symbols generated according to embodiments. For example, FIG. 8A and FIG. 8B show candidate symbols generated for a signal received based on 4096-QAM in a signal constellation. In 4096-QAM, a symbol may be defined as 6 bits of the real part (in other words, b₀, b₁, b₂, b₃, b₄ and b₅) and 6 bits of the imaginary part (in other words, b₆, b₇, b₈, b₉, b₁₀ and b₁₁).

In some example embodiments, candidate symbols and additional candidate symbols included in a square region including the reference symbol may be generated. For example, as illustrated in FIG. 8A, the candidate symbols may include 5×5 candidate symbols SQ centered around a reference symbol REF and a first mirror symbol MR1 to a sixth mirror symbol MR6. The first to twenty fifth Euclidean distances (ED[0:24]) may be computed from the 5×5 candidate symbols SQ, and twenty sixth to thirty first Euclidean distances (ED[25:30]) may be computed from the first mirror symbol MR1 to the sixth mirror symbol MR6.

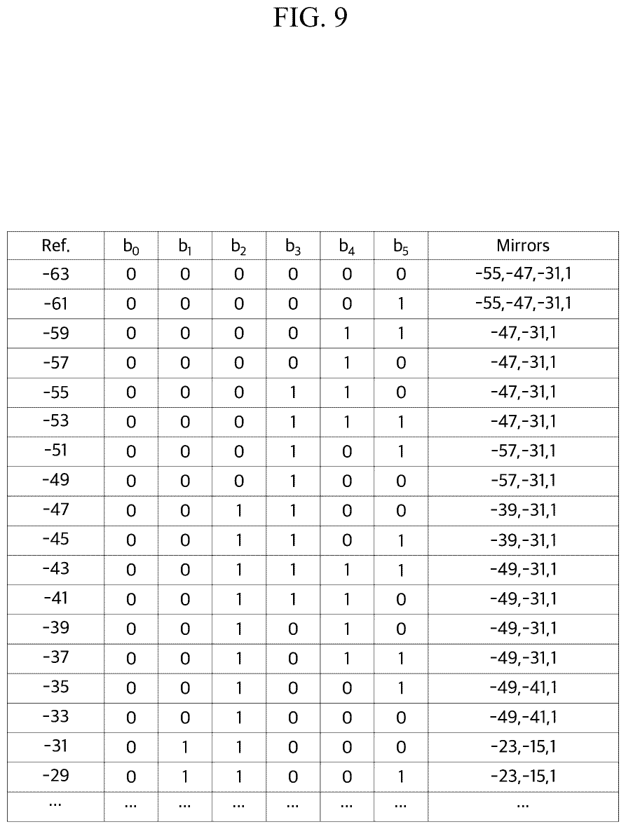

In some example embodiments, the first mirror symbol MR1 to the sixth mirror symbol MR6 may have a real part or an imaginary part that is identical to a real part or an imaginary part of the reference symbol REF. For example, as illustrated in FIG. 8A, the first mirror symbol MR1 to a third mirror symbol MR3 may have the same imaginary part as the reference symbol REF, and a fourth mirror symbol MR4 to the sixth mirror symbol MR6 may have the same real part as the reference symbol REF. The 5×5 candidate symbols SQ may include five consecutive symbols centered around the reference symbol REF. In five consecutive symbols, any three bits among b₀, b₁, b₂, b₃, b₄ and b₅ may be 0 or 1. The remaining three bits may only be 0 or 1. Accordingly, in order for the three bits that only have 0 or 1 to have 1 or 0, six additional candidate symbols may be added, namely the first mirror symbol MR1 to the sixth mirror symbol MR6. Example embodiments of mirror symbols added according to the reference symbol will be described later with reference to FIG. 9.

Referring to FIG. 8B, the reference symbol may be close to a boundary in the signal constellation. For example, as illustrated in FIG. 8B, when the bits of the reference symbol, in other words, b₀, b₁, b₂, b₃, b₄, b₅, b₆, b₇, b₈, b₉, b₁₀, and b₁₁, are “111010000001,” five consecutive symbols centered around the reference symbol may not be occurred. In this case, since only 2 bits, in other words, b₄ and b₅, may be 0 or 1 in the 5×5 candidate symbols SQ, four mirror symbols could be added: “111010110000,” “111010011000,” “111010001100,” “111010001100” and “1111010000110.”

FIG. 9 illustrates a table including mirror symbols according to embodiments. For example, the table in FIG. 9 shows the values of the real part of the mirror symbol added according to the values of b₀, b₁, b₂, b₃, b₄ and b₅, which are real parts in 4096-QAM. As described above with reference to FIG. 8A and FIG. 8B, candidate symbols may include symbols within a square area centered around the reference symbol and mirror symbols.

When the real part of the reference symbol is greater than or equal to −59 and less than or equal to 59, as described above with reference to FIG. 8A, five consecutive symbols may occur centered around the reference symbol. 3-bits among b₀, b₁, b₂, b₃, b₄ and b₅ may only be 0 or 1, and accordingly, three nearest mirror symbols containing bits with values of 1 or 0 may be added. For example, when the real part of the reference symbol is −57, five consecutive symbols may be −53, −55, −57, −59 and −61, and b₀, b₁ and b₂ may only have 0. Accordingly, in order for b₀, b₁ and b₂ to have the value 1, three mirror symbols with real parts 1, −31 and −47 may be added as candidate symbols.

When the reference symbol approaches the boundary of the signal constellation, for example, if the real parts of the reference symbol are −63, −61, 61 and 63, five consecutive symbols may not occur around the reference symbol. In this case, since b₄ and b₅ may have values of 0 or 1, four mirror symbols may be added as described above with reference to FIG. 8B. For example, when the real part of the reference symbol is −61, four mirror symbols whose real parts are −55, −47, −31 and 1 may be added as candidate symbols.

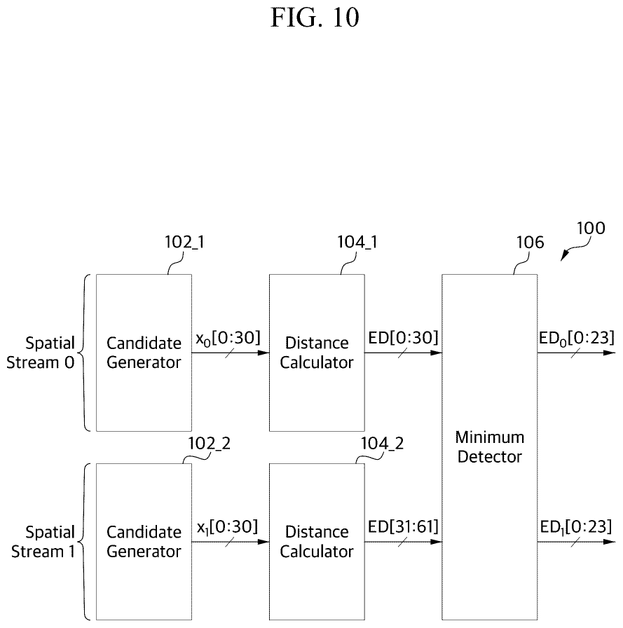

FIG. 10 is a block diagram illustrating a processing circuit 100 according to embodiments. For example, the block diagram of FIG. 10 illustrates the processing circuit 100 that uses some of the symbols supporting 4096-QAM in 2×2 MIMO as candidate symbols. As illustrated in FIG. 10, the processing circuit 100 may include a first candidate generator 102_1 and a first distance calculator 104_1 for spatial stream 0, may include a second candidate generator 102_2 and a second distance calculator 104_2 for spatial stream 1, and may include a minimum value detector 106.

Each of the first candidate generator 102_1 and the second candidate generator 102_2 may generate 31 candidate symbols as described above with reference to FIG. 8A and FIG. 8B. For example, as illustrated in FIG. 10, the first candidate generator 102_1 may generate 31 candidate symbols (x₀[0:30]) from spatial stream 0, and the second candidate generator 102_2 may generate 31 candidate symbols (x₁[0:30]) from spatial stream 1.

The first distance calculator 1041 may compute 31 Euclidean distances (ED[0:30]) from combinations of 31 candidate symbols of spatial stream 0 (x₀[0:30]) and 31 candidate symbols of hard detected spatial stream 1. The second distance calculator 104_2 may compute 31 Euclidean distances (ED[31:61]) from combinations of 31 candidate symbols of spatial stream 1 (x₁[0:30]) and 31 candidate symbols of hard detected spatial stream 0.

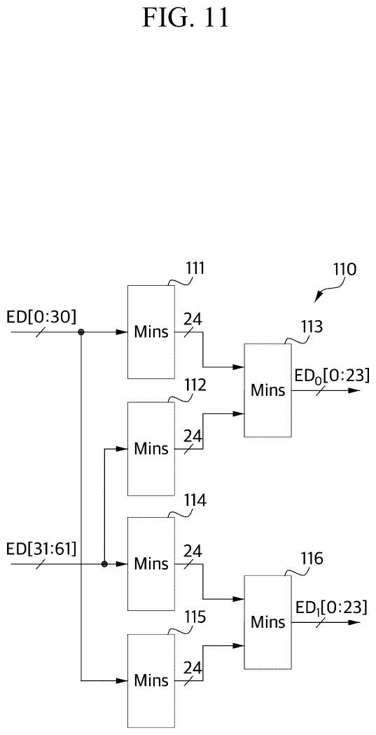

The minimum value detector 106 may receive 62 Euclidean distances (ED[0:61]). The minimum value detector 106 may detect a total of 24 minimum values (ED₀[0:23]), corresponding to 2 values each of the 12 bits of spatial stream 0, in other words, b_{0,0} to b_{0,11}. 24 minimum values (ED₀[0:23]) may be provided to the LLR calculator (for example, the LLR calculator 38 in FIG. 3), and the LLR calculator may compute LLR values of b_{0,0} to b_{0,11} of spatial stream 0. Further, the minimum value detector 106 may detect a total of 24 minimum values (ED₁[0:23]), corresponding to 2 values each of the 12 bits of spatial stream 1, in other words, b_{1,0} to b_{1,11}. 24 minimum values (ED₁[0:23]) may be provided to the LLR calculator (for example, the LLR calculator 38 in FIG. 3), and the LLR calculator may compute LLR values of b_{1,0} to b_{1,11} of spatial stream 1. Embodiments of the minimum value detector 106 will be described later with reference to FIG. 11.

FIG. 11 is a block diagram illustrating a minimum value detector 110 according to embodiments. For example, the minimum value detector 110 of FIG. 11 may be an example of the minimum value detector 106 of FIG. 10. As described above with reference to FIG. 10, the minimum value detector 110 of FIG. 11 may receive 62 Euclidean distances (ED[0:61]), and may generate 24 Euclidean distances corresponding to spatial stream 0 (ED₀[0:23]) and 24 Euclidean distances corresponding to spatial stream 1 (ED₁[0:23]). As illustrated in FIG. 11, the minimum value detector 110 may include a first minimum value operation block 111 to a sixth minimum value operation block 116.

The first minimum value operation block 111 may generate 24 Euclidean distances from the 31 Euclidean distances corresponding to spatial stream 0 (ED[0:30]). A second minimum value operation block 112 may generate 24 Euclidean distances from the 31 Euclidean distances (ED[31:61]) corresponding to spatial stream 1. 31 Euclidean distances (ED[31:61]) may correspond to hard decisioned symbols in spatial stream 0 based on candidate symbols in spatial stream 1. 24 Euclidean distances generated by each of the first minimum value operation block 111 and the second minimum value operation block 112 may include 12 Euclidean distances corresponding to 0 and 1 of each of the 6 bits of the real part, and 12 Euclidean distances corresponding to 0 and 1 of each of the 6 bits of the imaginary part in spatial stream 0. A third minimum value operation block 113 may generate 24 minimum values (ED₀[0:23]) corresponding to spatial stream 0, by comparing the 24 Euclidean distances provided from the first minimum value operation block 111 and the 24 Euclidean distances provided from the second minimum value operation block 112.

A fourth minimum value operation block 114 may generate 24 Euclidean distances from the 31 Euclidean distances (ED[31:61]) corresponding to spatial stream 1. A fifth minimum value operation block 115 may generate 24 Euclidean distances from the 31 Euclidean distances corresponding to spatial stream 0 (ED[0:30]). 31 Euclidean distances (ED[0:30]) may correspond to the hard decisioned symbols in spatial stream 1 based on the candidate symbols in spatial stream 0. 24 Euclidean distances generated by each of the fourth minimum value operation block 114 and the fifth minimum value operation block 115 may include 12 Euclidean distances corresponding to 0 and 1 of each of the 6 bits of the real part and 12 Euclidean distances corresponding to 0 and 1 of each of the 6 bits of the imaginary part, in spatial stream 1. The sixth minimum value operation block 116 may generate 24 minimum values (ED₁[0:23]) corresponding to spatial stream 1 by comparing 24 Euclidean distances provided from the fourth minimum value operation block 114 and 24 Euclidean distances provided from the fifth minimum value operation block 115.

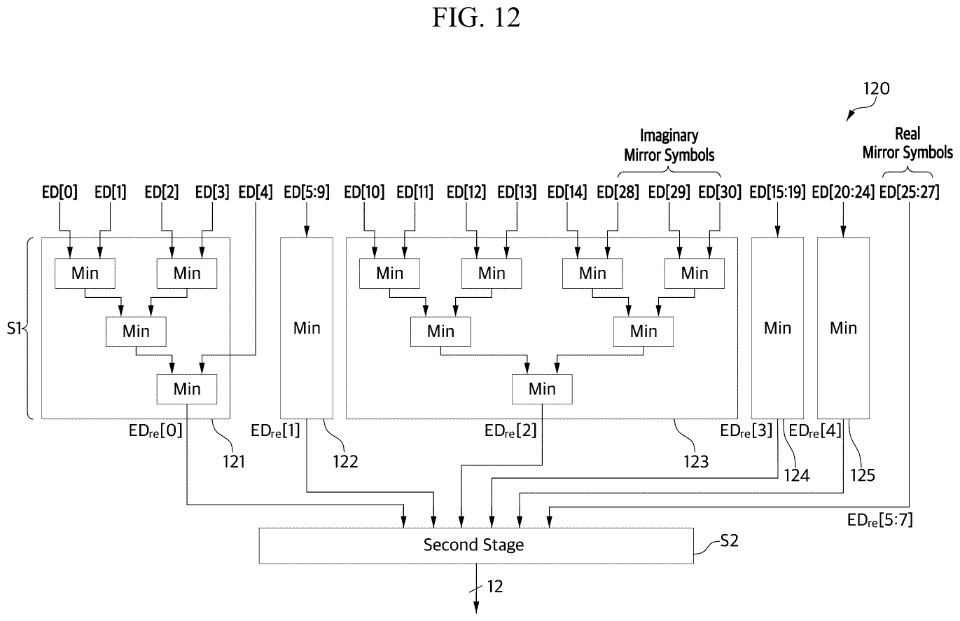

In some example embodiments, as described above with reference to the drawings, each of the first minimum value operation block 111, the second minimum value operation block 112, the fourth minimum value operation block 114, and the fifth minimum value operation block 115 may include a first stage and a second stage, and may include a reduced number of minimum value calculators. Example embodiments of the first minimum value operation block 111, the second minimum value operation block 112, the fourth minimum value operation block 114 and the fifth minimum value operation block 115 will be described below with reference to FIG. 12.

FIG. 12 is a block diagram illustrating a minimum value operation block 120 according to embodiments. For example, the block diagram in FIG. 12 illustrates an example of a structure that generates 12 Euclidean distances corresponding to the 6 bits of the real part in the first minimum value operation block 111, the second minimum value operation block 112, the fourth minimum value operation block 114 and the fifth minimum value operation block 115 of FIG. 11, respectively. Each of the first minimum value operation block 111, the second minimum value operation block 112, the fourth minimum value operation block 114 and the fifth minimum value operation block 115 of FIG. 11 may further include a structure corresponding to 6 bits of the imaginary part, similar to that illustrated in FIG. 12.

Referring to FIG. 12, the minimum value operation block 120 may include the first stage S1 and the second stage S2. The first stage S1 may include a first minimum value operation block 121 to a fifth minimum value operation block 125. In some example embodiments, a second minimum value operation block 122, a fourth minimum value operation block 124 and the fifth minimum value operation block 125 may have the same structure as the first minimum value operation block 121. The first stage S1 may generate the first to eighth real part Euclidean distances (EDᵣₑ[0:7]) from the first to thirty first Euclidean distances (ED[0:31]). As described above with reference to FIG. 8A, the twenty sixth to twenty eighth Euclidean distances (ED[25:27]) may correspond to real number mirror symbols, and the twenty ninth to thirty first Euclidean distances (ED[28:30]) may correspond to imaginary mirror symbols.

The first minimum value operation block 121 may include five minimum value calculators, and generate the first real part Euclidean distance (EDᵣₑ[0]), which is the minimum value among the first to fifth Euclidean distances (ED[0:4]). The second minimum value operation block 122 may generate the second real part Euclidean distance (EDᵣₑ[1]), which is the minimum value among the sixth to tenth Euclidean distances (ED[5:9]). A third minimum value operation block 123 may generate the third real part Euclidean distance (EDᵣₑ[2]) from the eleventh to fifteenth Euclidean distances (ED[10:14]) and the twenty ninth to thirty first Euclidean distances (ED[28:30]). The fourth minimum value operation block 124 may generate the fourth real part Euclidean distance (EDᵣₑ[3]) from the 16th to 20th Euclidean distances (ED[15:19]), and the fifth minimum value operation block 125 may generate the fifth real part Euclidean distance (EDᵣₑ[4]) from the twenty first to twenty fifth Euclidean distances (ED[20:24]). The twenty sixth to twenty eighth Euclidean distances (ED[25:27]) may be provided to the second stage S2 as the sixth to eighth real part Euclidean distances (EDᵣₑ[5:7]).

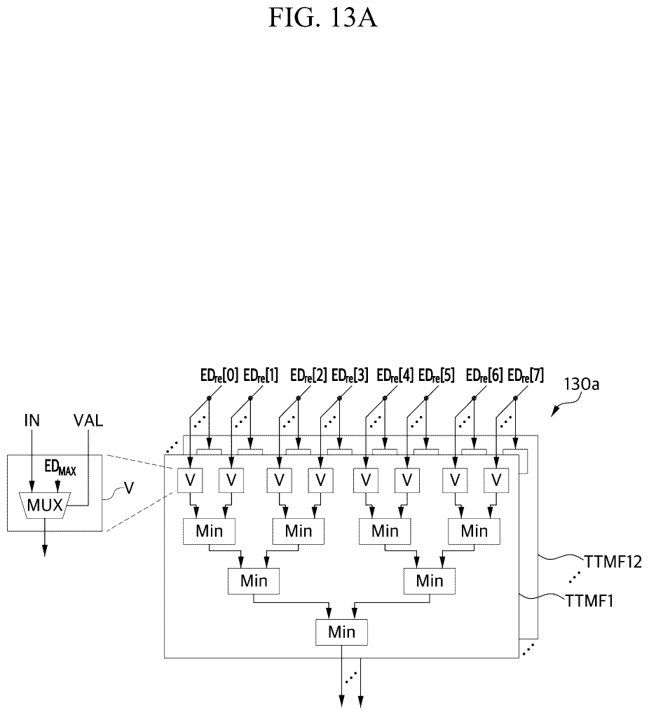

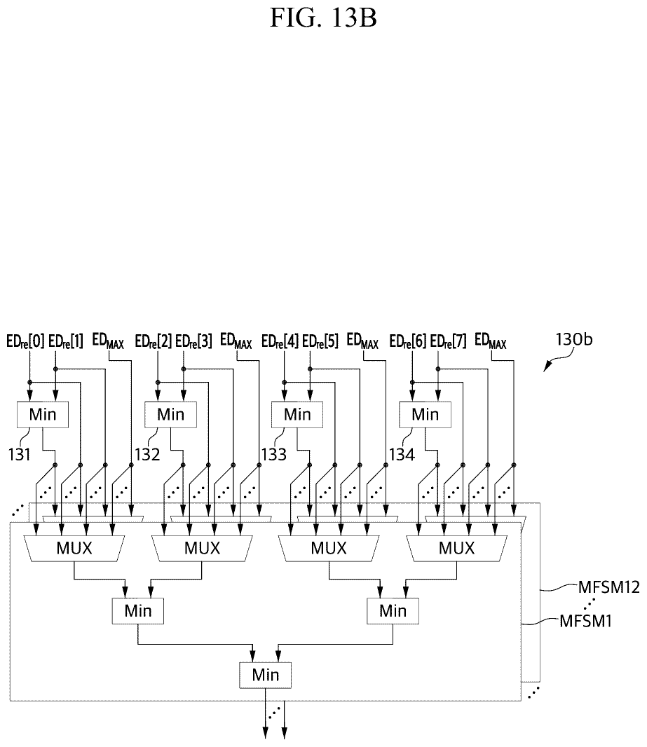

The second stage S2 may generate 12 minimum values corresponding to 6-bit real part from the first to eighth real part Euclidean distances (EDᵣₑ[0:7]). Example embodiments of the second stage S2 will be described below with reference to FIG. 13A and FIG. 13B.

FIG. 13A and FIG. 13B are block diagrams illustrating a minimum value operation block according to embodiments. For example, the block diagrams in FIG. 13A and FIG. 13B illustrate examples of the second stage S2 of FIG. 12. As described above with reference to FIG. 12, each of a second stage 130a of FIG. 13A and a second stage 130b of FIG. 13B may generate 12 minimum values from the first to eighth real part Euclidean distances (EDᵣₑ[0:7]).

Referring to FIG. 13A, the second stage 130a may include a first minimum value operation block TTMF1 to a twelfth minimum value operation block TTMF12. The first minimum value operation block TTMF1 to the twelfth minimum value operation block TTMF12 may have the same structure. In order to filter out symbols that are not included in the candidate symbols among all symbols of 4096-QAM, the first minimum value operation block TTMF1 to the twelfth minimum value operation block TTMF12 may include a verification operator V. As illustrated in FIG. 13A, the verification operator V may include a multiplexer MUX, and the multiplexer MUX may output the Euclidean distance (IN) or the maximum Euclidean distance (ED_{MAX}) depending on the value of a signal VAL indicating whether the Euclidean distance (IN) is valid. In other words, in the case of the symbol whose Euclidean distance (IN) input to the verification operator V is not included in the candidate symbols, in other words, in the case of a symbol outside of ICR, the maximum Euclidean distance (ED_{MAX}) may be chosen so that the Euclidean distance (IN) is excluded in subsequent minimum value operations. As illustrated in FIG. 13A, the first minimum value operation block TTMF1 may include eight verification operators each receiving the first to eighth real part Euclidean distances (EDᵣₑ[0:7]). Further, the first minimum value operation block TTMF1 may include seven minimum value calculators in a tree structure to obtain the minimum value from the outputs of eight verification operators.

Referring to FIG. 13B, the second stage 130b may include a first minimum value calculator 131 to a fourth minimum value calculator 134, and include a first minimum value operation block MFSM1 to a twelfth minimum value operation block MFSM12. The first minimum value operation block MFSM1 to the twelfth minimum value operation block MFSM12 may have the same structure. As illustrated in FIG. 13B, the first minimum value operation block MFSM1 may include four multiplexers MUX and three minimum value calculators. When compared to the second stage 130a of FIG. 13A, in the second stage 130b of FIG. 13B, the multiplexers MUX may be placed after the first minimum value calculator, that is, the first minimum value calculator 131 to the fourth minimum value calculator 134, and outputs of the first minimum value calculator 131 to the fourth minimum value calculator 134 may be shared.

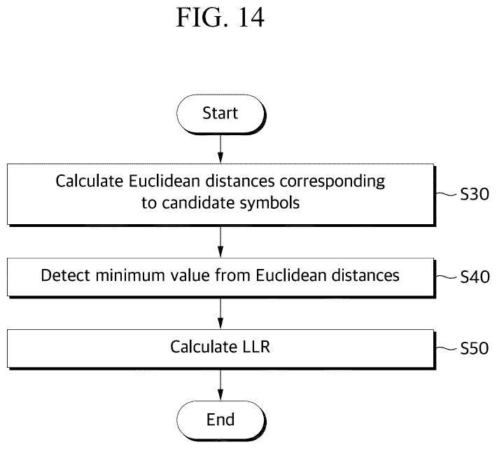

FIG. 14 is a flowchart illustrating a method for detecting a symbol according to embodiments. As illustrated in FIG. 14, the method of detecting a symbol may include operation S30, operation S40 and operation S50. In some example embodiments, FIG. 14 may be performed by the processing circuit 30 of FIG. 3. Hereinafter, FIG. 14 will be described with reference to FIG. 3.

Referring to FIG. 14, in operation S30, Euclidean distances corresponding to candidate symbols may be computed. For example, the distance calculator 34 may receive candidate symbols from the candidate generator 32 and calculate Euclidean distances corresponding to the candidate symbols.

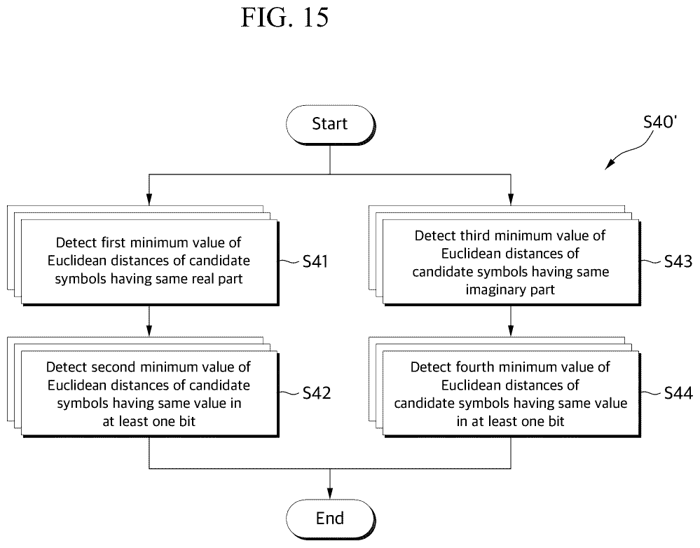

In operation S40, the minimum value among Euclidean distances may be detected. For example, the minimum value detector 36 may detect minimum values from Euclidean distances calculated in operation S30. As described above with drawings, the minimum value detector 36 may include a first stage that detects the minimum value of Euclidean distances corresponding to candidate symbols having the same real part (or imaginary part), and may include a second stage for detecting the minimum value of Euclidean distances corresponding to candidate symbols having the same value in at least one bit of the real part (or imaginary part). Accordingly, the minimum value detector 36 may detect minimum values using reduced resources. Operation S40 will be described later with reference to FIG. 15.

In operation S50, an LLR may be calculated. For example, the LLR calculator 38 may calculate an LLR based on the minimum values detected in operation S40. In some example embodiments, the LLR calculator 38 may calculate an LLR for each bit of a symbol based on [Equation 4].

FIG. 15 is a flowchart illustrating a method for detecting a symbol according to embodiments. For example, the flowchart of FIG. 15 illustrates an example of operation S40 of FIG. 14. As described above with reference to FIG. 14, in operation S40′ of FIG. 15, the minimum value among Euclidean distances may be detected. As illustrated in FIG. 15, operation S40′ may include operation S41 to operation S44. In some example embodiments, operation S41 and operation S42 may be performed in parallel with operation S43 and operation S44. In some example embodiments, operation S40′ may be performed by the minimum value detector 36 of FIG. 3. Hereinafter, FIG. 15 will be described with reference to FIG. 3.

Referring to FIG. 15, in operation S41, the first minimum value of Euclidean distances of candidate symbols having the same real part may be detected. For example, the minimum value detector 36 may include a first stage that detects a first minimum value from Euclidean distances of candidate symbols having the same real part. The first stage may detect the first minimum values respectively corresponding to values of the real part.

In operation S42, the second minimum value of the Euclidean distances of candidate symbols having the same value in at least one bit may be detected. For example, the minimum value detector 36 may include a second stage for detecting a second minimum value of Euclidean distances of candidate symbols having the same value in at least one bit of the real part based on the first minimum values detected in operation S41.

In operation S43, the third minimum value of the Euclidean distances of candidate symbols having the same imaginary part may be detected. For example, the minimum value detector 36 may include a first stage for detecting the third minimum value from the Euclidean distances of candidate symbols having the same imaginary part. The first stage may detect the third minimum values respectively corresponding to values of the real part.

In operation S44, the fourth minimum value of the Euclidean distances of candidate symbols having the same value in at least one bit may be detected. For example, the minimum value detector 36 may include a second stage for detecting a fourth minimum value of Euclidean distances of candidate symbols having the same value in at least one bit of the imaginary part based on the third minimum values detected in operation S43.

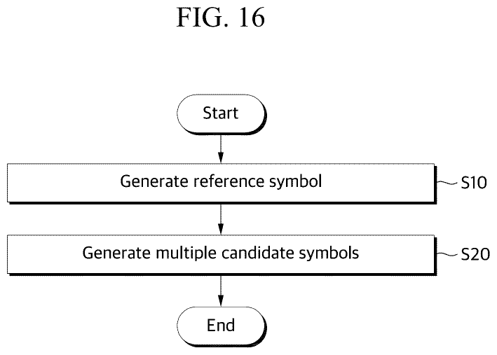

FIG. 16 is a flowchart illustrating a method for detecting a symbol according to embodiments. As illustrated in FIG. 16, the method for detecting a symbol may include operation S10 and operation S20. In some example embodiments, operation S10 and operation S20 may be performed prior to operation S30 of FIG. 14. In some example embodiments, operation S10 and operation S20 may be performed by the candidate generator 32 of FIG. 3. In the following, FIG. 16 will be described with reference to FIG. 3.

Referring to FIG. 16, a reference symbol may be generated in operation S10. For example, the candidate generator 32 may generate a reference symbol from each of the spatial streams based on the input signal. In some example embodiments, the candidate generator 32 may include an MMSE estimator, and the MMSE estimator may compute a reference symbol based on [Equation 9].

In operation S20, a plurality of candidate symbols may be generated. For example, the candidate generator 32 may generate multiple candidate symbols including the reference symbol generated in operation S10. Instead of the exhaustive search, which uses all symbols of the modulation scheme as candidate symbols, resources consumed for symbol detection may be reduced through ICR, which uses some symbols as candidate symbols. Example embodiments of operation S20 will be described with reference to FIG. 17.

FIG. 17 is a flowchart illustrating a method for detecting a symbol according to embodiments. For example, the flowchart of FIG. 17 shows embodiments of operation S20 of FIG. 16. As described above with reference to FIG. 16, a plurality of candidate symbols may be generated in operation S20′. As illustrated in FIG. 17, operation S20′ may include operation S21 to operation S24. In some example embodiments, operation S21 and operation S22 may be performed in parallel with operation S23 and operation S24. In some example embodiments, operation S20′ may be performed by the candidate generator 32 of FIG. 3. In the following, FIG. 17 will be described with reference to FIG. 3.

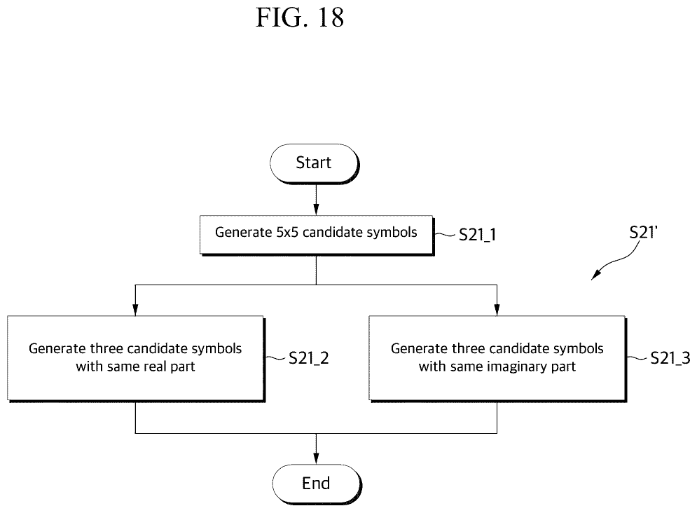

Referring to FIG. 17, in operation S21, first candidate symbols of the first spatial stream may be generated based on the first reference symbol. For example, a signal may be received via two or more spatial streams, including a first spatial stream and a second spatial stream, and the candidate generator 32 may generate first candidate symbols of the first spatial stream based on a first reference symbol of the first spatial stream. In some example embodiments, the candidate generator 32 may generate some of the symbols of the modulation scheme as first candidate symbols. Embodiments of operation S21 will be described with reference to FIG. 18.

In operation S22, second candidate symbols of a second spatial stream may be generated based on the first candidate symbols. For example, the candidate generator 32 may generate second candidate symbols of a second spatial stream from the first candidate symbols of the first spatial stream generated in operation S21. In some example embodiments, the candidate generator 32 may generate second candidate symbols from first candidate symbols based on [Equation 10].

In operation S23, the third candidate symbols of the second spatial stream may be generated based on the second reference symbol. For example, the candidate generator 32 may generate third candidate symbols of the second spatial stream based on the second reference symbol of the second spatial stream. In some example embodiments, the candidate generator 32 may generate some of the symbols of the modulation scheme as third candidate symbols. Embodiments of operation S23 will be described with reference to FIG. 18.

In operation S24, fourth candidate symbols of the first spatial stream may be generated based on the third candidate symbols. For example, the candidate generator 32 may generate fourth candidate symbols of the first spatial stream from third candidate symbols of the second spatial stream generated in operation S23. In some example embodiments, the candidate generator 32 may generate fourth candidate symbols from the third candidate symbols based on [Equation 10].

FIG. 18 is a flowchart illustrating a method for detecting a symbol according to embodiments. For example, the flowchart of FIG. 18 shows examples of operation S21 and operation S23 of FIG. 17. As described above with reference to FIG. 18, in operation S21′ of FIG. 18, a plurality of candidate symbols may be generated. As illustrated in FIG. 18, operation S21′ may include a plurality of operations (operation S21_1 to operation S21_3). In some example embodiments, operation S21_2 and operation S21_3 may be performed in parallel. In some example embodiments, operation S21′ may be performed by the candidate generator 32 of FIG. 3. In the following, FIG. 18 will be described with reference to FIG. 3.

Referring to FIG. 18, in operation S21_1, 5×5 candidate symbols may be generated. For example, as described above with reference to FIG. 8A, the candidate generator 32 may generate 5×5 symbols including the reference symbol at the center in the signal constellation as candidate symbols. When the reference symbol is close to the boundary of the signal constellation, as described above with reference to FIG. 8B, the candidate generator 32 may generate less than 5×5 candidate symbols.

In operation S21_2, three candidate symbols with the same real part may be generated. For example, the candidate generator 32 may generate three candidate symbols whose real part is identical to the real part of the reference symbol. As described above with reference to FIG. 8A, the 5×5 candidate symbols generated in operation S21_1 may include three bits of the real part that may only be 0 or 1. The candidate generator 32 may add three candidate symbols so that three bits of the real part are 0 or 1. As described above with reference to FIG. 8B, when the reference symbol approaches the boundary of the signal constellation, the candidate generator 32 may add candidate symbols, with excess of 3 candidate symbols.

In operation S21_3, three candidate symbols with the same imaginary part may be generated. For example, the candidate generator 32 may generate three candidate symbols having imaginary parts identical to the imaginary part of the reference symbol. As described above with reference to FIG. 8A, 5×5 candidate symbols generated in operation S21_1 may include three bits of the imaginary part that have only 0 or 1. The candidate generator 32 may add three candidate symbols so that the three bits of the imaginary part are 0 or 1. As described above with reference to FIG. 8B, when the reference symbol approaches the boundary of the signal constellation, the candidate generator 32 may add candidate symbols, with excess of 3 candidate symbols.

FIG. 19 is a drawing illustrating devices for wireless communication according to embodiments. Specifically, FIG. 19 illustrates an Internet of Things (IoT) network system including a home gadget 191, home appliances 192, an entertainment device 193 and an access point 195. In some example embodiments, the symbol may be detected in devices for wireless communication of FIG. 19 as described above with reference to the drawings. Accordingly, devices for wireless communication may detect symbols with reduced resources, and may have low cost and power consumption.

As described above, example embodiments are disclosed with respect to the drawings in the present disclosure. In the present disclosure, the example embodiments are described using specific terms, but the terms are used solely for the purpose of explaining the technical ideas of the present disclosure and are not intended to limit the meaning or scope of the present disclosure as set forth in the claims. Therefore, those skilled in the art will understand that various modifications and equivalent example embodiments are possible from this.

What is claimed is:

1. A device configured to detect a symbol from an input signal, the device comprising:
a Euclidean distance calculator configured to calculate a plurality of Euclidean distances corresponding to a plurality of candidate symbols;
a minimum value detector configured to detect a minimum value among the plurality of Euclidean distances; and
a log-likelihood ratio (LLR) calculator configured to calculate an LLR based on the minimum value,
wherein the minimum value detector comprises:
a first circuit configured to detect a first minimum value of Euclidean distances corresponding to candidate symbols having an identical real part among the plurality of candidate symbols; and
a second circuit configured to detect a second minimum value of Euclidean distances corresponding to candidate symbols having an identical value in at least one bit of the real part among the plurality of candidate symbols, from a plurality of first minimum values comprising the first minimum value.

2. The device of claim 1, wherein the minimum value detector further comprises:
a third circuit configured to detect a third minimum value of Euclidean distances corresponding to candidate symbols having an identical imaginary part among the plurality of candidate symbols; and
a fourth circuit configure to detect a fourth minimum value of Euclidean distances corresponding to candidate symbols having an identical value in at least one bit of the imaginary part among the plurality of candidate symbols, from a plurality of third minimum values comprising the third minimum value.

3. The device of claim 1, wherein the plurality of candidate symbols comprise all symbols of a scheme in which the input signal is modulated.

4. The device of claim 1, wherein a number of the plurality of candidate symbols is less than a total number of symbols of a scheme in which the input signal is modulated.

5. The device of claim 4, further comprising a candidate generator configured to:
generate a reference symbol based on the input signal; and
generate the plurality of candidate symbols based on the reference symbol.

6. The device of claim 5, wherein the scheme is quadrature amplitude modulation (4096-QAM), and
wherein the candidate generator is configured to generate the plurality of candidate symbols comprising 5×5 symbols comprising the reference symbol and additional six symbols in a signal constellation.

7. The device of claim 6, wherein the additional six symbols comprise:
three symbols comprising a real part that is identical to a real part of at least one of the 5×5 symbols; and
three symbols comprising an imaginary part that is identical to an imaginary part of at least one of the 5×5 symbols.

8. The device of claim 5, wherein the input signal is received through a first spatial stream and a second spatial stream, and
wherein the candidate generator is configured to:
generate first candidate symbols based on first reference symbol corresponding to the first spatial stream; and
generate second candidate symbols corresponding to the second spatial stream based on the first candidate symbols.

9. A method of detecting a symbol from an input signal, the method comprising:
calculating a plurality of Euclidean distances corresponding to a plurality of candidate symbols;
detecting a minimum value among the plurality of Euclidean distances; and
calculating an LLR based on the minimum value,
wherein detecting the minimum value comprises:
detecting a first minimum value of Euclidean distances corresponding to candidate symbols having an identical real part among the plurality of candidate symbols; and
detecting a second minimum value of Euclidean distances corresponding to candidate symbols having an identical value in at least one bit of the real part among the plurality of candidate symbols, from a plurality of first minimum values comprising the first minimum value.

10. The method of claim 9, wherein detecting the minimum value further comprises:
detecting a third minimum value of Euclidean distances corresponding to candidate symbols having an identical imaginary part among the plurality of candidate symbols; and
detecting a fourth minimum value of Euclidean distances corresponding to candidate symbols having an identical value in at least one bit of the imaginary part among the plurality of candidate symbols, from a plurality of third minimum values comprising the third minimum value.

11. The method of claim 9, wherein the plurality of candidate symbols comprise all symbols of a scheme in which the input signal is modulated.

12. The method of claim 9, wherein a number of the plurality of candidate symbols is less than a total number of symbols of a scheme in which the input signal is modulated.

13. The method of claim 12, further comprising:
generating a reference symbol based on the input signal; and
generating the plurality of candidate symbols based on the reference symbol.

14. The method of claim 13, wherein the scheme is 4096-QAM, and
wherein generating the plurality of candidate symbols comprises generating the plurality of candidate symbols comprising 5×5 candidate symbols comprising the reference symbol and additional six candidate symbols in a signal constellation.

15. The method of claim 14, wherein the additional six candidate symbols comprise:
three symbols comprising a real part that is identical to a real part of at least one among the 5×5 candidate symbols; and
three symbols comprising an imaginary part that is identical to an imaginary part of at least one of the 5×5 candidate symbols.

16. The method of claim 13, wherein the input signal is received through a first spatial stream and a second spatial stream, and
wherein generating the plurality of candidate symbols comprises:
generating first candidate symbols based on first reference symbol corresponding to the first spatial stream; and
generating second candidate symbols corresponding to the second spatial stream based on the first candidate symbols.

17. A method of detecting a symbol from an input signal, the method comprising:
generating a reference symbol based on the input signal;
generating a plurality of candidate symbols based on the reference symbol;
calculating a plurality of Euclidean distances corresponding to the plurality of candidate symbols;
detecting a minimum value among the plurality of Euclidean distances; and
calculating an LLR based on the minimum value,
wherein generating the plurality of candidate symbols comprises:
generating 5×5 first candidate symbols comprising the reference symbol in a signal constellation;
generating three second candidate symbols having a real part that is identical to a real part of at least one among the first candidate symbols; and
generating three third candidate symbols having an imaginary part that is identical to an imaginary part of at least one among the first candidate symbols.

18. The method of claim 17, wherein the plurality of candidate symbols comprise all symbols of a scheme in which the input signal is modulated.

19. The method of claim 18, wherein the scheme in which the input signal is modulated is 4096-QAM.

20. The method of claim 17, wherein the input signal is received through a first spatial stream and a second spatial stream,
wherein the first candidate symbols, the second candidate symbols and the third candidate symbols correspond to the first spatial stream, and
wherein generating the plurality of candidate symbols comprises generating fourth candidate symbols corresponding to the second spatial stream based on the first candidate symbols, the second candidate symbols and the third candidate symbols.
